(19) United States
(12) Patent Application Publication
(10) Pub. No.: US 2020/0223032 A1
(43) Pub. Date: Jul. 16, 2020

(54) MODULAR CLAMP BASE

(71) Applicant: Honda Motor Co., Ltd., Tokyo (JP)

(72) Inventors: Samuel T. Bartlett, JR., Marysville, OH (US); John T. Eureka, Hilliard, OH (US)

(21) Appl. No.: 16/249,266

(22) Filed: Jan. 16, 2019

(51) Int. Cl. B25B 5/16

(52) U.S. Cl. CPC B25B 5/16; B25B 11/005

(57) ABSTRACT

A modular clamp base for manipulating a target object includes at least two interchangeable side plates and a central gripping member. The interchangeable side plates are configured to detachably attach to opposing surfaces of the central gripping member. The central gripping member includes an attachment end proximal to a lower end of the central gripping member; the attachment end configured to detachably attach to the target object.

### BACKGROUND

Machine shop floors, maintenance facilities, automotive assembly lines and the like employ multiple article holding assemblies and robots for handling and assembling articles such as automotive panels, automotive engine blocks, etc. With increasing automation in assembly lines, existing robots are capable of executing entire assembling processes. However, such capabilities are limited by availability of a suitable end effector or end-of-arm tool (EOAT) for a particular process. An end effector is any tool or device at the end of a robotic arm configured to interact with its work environment to execute an intended function. As such, an end effector that is easily mounted and changeable based on the process to be carried out is desired.

Currently, existing end effectors or end-of-arm tool (EOAT) subassemblies use multiple clamping elements such as a clamp unit, for example, P-clamp unit, pneumatic clamps etc., each of which are formed from a single block of cast iron molded in a predefined shape. Such clamp units are custom manufactured to mate with a specific workpiece, or a component, for example, an automotive panel, an automotive engine block, etc., to allow assembly or maneuvering of the component. Since existing clamp units are manufactured from a single block of cast iron, a larger dimensioned clamp unit required to handle a larger vehicle component equates to a larger mass bearing component subsequently requiring more power to drive operation of the end effector. An alternative, that is substantially lighter than existing clamp units and has lower power requirements, is therefore desired.

Typically, clamp units undergo wear with prolonged usage that may require replacement. As such, when the clamp units are completely worn and cannot be used, the used clamp units must be scrapped and a new clamp unit built as a replacement. Sometimes, only small portions of a new clamp unit may be worn out rendering the entire clamp unit unusable. This leads to increased material waste. Further, existing clamp units are designed to be compatible with only a particular vehicle component, for example, a particular engine block model, a particular transmission component, a particular vehicle body panel, etc. In an assembly line that requires working with or assembling multiple vehicle makes or models, a clamp unit that must be replaced frequently to match the component being assembled leads to reduced production and increased assembly time. As such, a clamp unit that is of a modular or interchangeable design permitting quick replacement or rebuilding of the clamp unit is desired.

Thus, there exists a need in the art for a clamp unit that is easily mounted and changeable based on the process to be carried out. Moreover, there is a need for a clamp unit that is substantially lighter than existing clamp units and has lower power requirements. Furthermore, there is a need for a clamp unit that is of a modular or interchangeable design permitting quick replacement or rebuilding of the clamp unit.

### SUMMARY

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

According to one embodiment, a subassembly for manipulating a target object, disclosed herein, includes at least two interchangeable side plates and a central gripping member. The interchangeable side plates are configured to detachably attach to opposing surfaces of the central gripping member. The central gripping member includes an attachment end proximal to a lower end of the central gripping member. In an embodiment, the attachment end is configured to manipulate the target object.

According to another embodiment, a modular clamp base for manipulating a target object includes at least two interchangeable side plates, a male attachment member, and a central gripping member. Each of the interchangeable side plates includes a hole configured to coaxially align with a hole configured in the central gripping member and sandwich the central gripping member between the at least two interchangeable side plates. The male attachment member is configured to be inserted into the hole of each of the interchangeable side plates and the hole of the central gripping member to detachably attach the interchangeable side plates to opposing surfaces of the central gripping member. The central gripping member includes an attachment end, which is proximal to a lower end of the central gripping member for detachably attaching to and securely manipulate and grip the target object.

According to a further embodiment, a method for manipulating a target object includes selecting at least two interchangeable side plates and a central gripping member of a modular clamp base depending on a type or size of a target object, for example, a gripping arm, a vacuum suction cup, a swing arm tool, a vehicle component, etc. Next, the modular clamp base is assembled by attaching the selected interchangeable side plates to opposing surfaces of the central gripping member. Then, the assembled modular clamp base is mounted to a drive mechanism of a robotic platform, for example, a pneumatic drive, an electric drive, etc. Finally, the target object is attached to an attachment end of the central gripping member of the modular clamp base to manipulate the target object.

### BRIEF DESCRIPTION OF THE DRAWINGS:

The foregoing summary, as well as the following detailed description of the present disclosure, is better understood when read in conjunction with the appended drawings. For the purpose of illustrating the present disclosure, exemplary constructions of one or more embodiments are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a perspective view of an embodiment of a subassembly implemented in an end-of-arm tool (EOAT);

FIG. 2 exemplarily illustrates a perspective view of an embodiment of an assembled modular clamp base;

FIG. 3 exemplarily illustrates an exploded perspective view of the modular clamp base provided in FIG. 2; and

FIG. 4 exemplarily illustrates a flowchart showing a method for manipulating a target object.

### DETAILED DESCRIPTION

A robotic platform or robotic arm or manipulator may refer to a mechanical arm or a part of a complex robot or any device that facilitates handling of a target object. As used herein, the target object may range from objects such as a silicon wafer to a vehicle component, for example, a metal sheet, a body panel, an engine component, etc. The target object may also be construed to refer to a gripping arm, a vacuum suction cup, a clamping tool, a swing arm tool, etc. In some implementations, an intermediate supporting member or clamping member may be provided to securely support or clamp the target object to a modular clamp base, subassembly, or other drive unit. As used herein, an end effector or the subassembly refers to a device or tool subassembly, for example, a clamp unit, modular clamp base, etc., configured to be mounted on a drive mechanism of a robotic platform or robotic arm or manipulator for handling the target object.

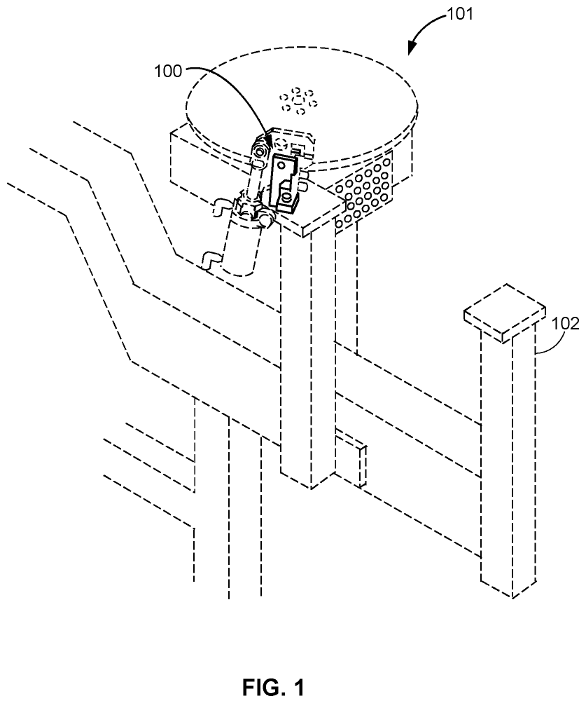

FIG. 1 exemplarily illustrates a perspective view of an embodiment of a subassembly 100 implemented in an end-of-arm tool (EOAT). The subassembly 100 may be operably connected to a robotic platform 101 of the EOAT. Further, the EOAT may comprise a plurality of vertical, horizontal, or combination of vertical and horizontal support members 102. The subassembly 100 is, for example, a clamp unit or modular clamp base 100 configured to locate, clamp, or secure sheet metal body parts of a vehicle in position during manufacturing of a welded car body. As such, multiple subassemblies 100 may be provided on each of the multiple support members 102 so that they are aligned or positioned to optimally weld the car body. Although the subassembly 100 illustrated in FIG. 1 is used in tandem with the EOAT, several other applications of the subassembly 100 may be envisioned. For instance, the subassembly 100 may be used in a swing unit, a rotary drive unit, or a linear drive unit.

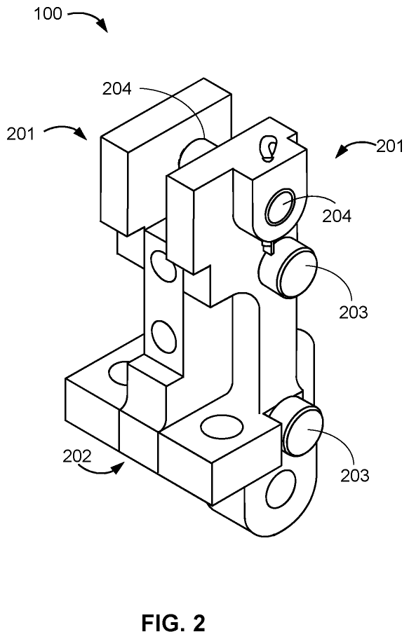

FIG. 2 exemplarily illustrates a perspective view of an embodiment of an assembled modular clamp base 100. The modular clamp base 100 for manipulating a target object, disclosed herein, includes three sections, which include at least two interchangeable side plates 201 and a central gripping member 202. In one embodiment, the interchangeable side plates 201 may be made of identical materials or dissimilar materials. For example, both the interchangeable side plates 201 may be made of an aluminum material, a heat-treated metallic material, an anodized aluminum material, an alloy, or a plastic material. Alternately, one of the interchangeable side plates 201 may be made of a metallic or aluminum material while the other interchangeable side plate 201 may be made of a plastic material. The choice of material used may be based on multiple criteria such as, for example, a size of a target object, a mass of a target object, type of operation to be carried out, etc.

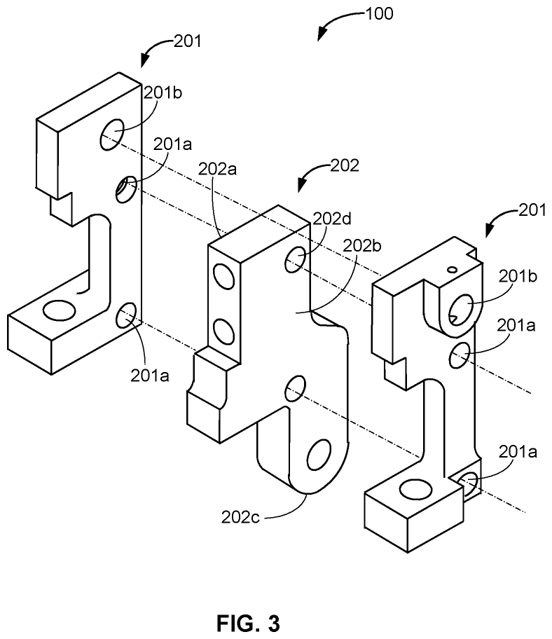

In an embodiment, the interchangeable side plates 201 are configured to detachably attach to opposing surfaces of the central gripping member 202 using a male attachment member 203. Although, the exemplary drawings illustrate the interchangeable side plates 201 being detachably attached to the central gripping member 202 via a single male attachment member 203, more than one male attachment members 203 may be envisioned for detachably attaching the interchangeable side plates 201 to the central gripping member 202. In an embodiment, the male attachment member 203 may include, for example, a shoulder bolt, nut bolt arrangement, a partially threaded bolt, a friction fit fastener etc. Alternately, the male attachment member 203 may include any fastening element that permits detachable attachment of the interchangeable side plates 201 to the central gripping member 202, for example, the two interchangeable side plates 201 may be attached using suitable industrial adhesives, such as, for example, acrylic adhesives, epoxy adhesives, hot melt adhesives, polyurethane adhesives, silicone adhesives, thermoset adhesives, UV curing adhesives, etc. The choice of the male attachment member 203 may be based on the selected type of interchangeable side plate 201 material and the type of material of the central gripping member 202. The central gripping member 202 includes an attachment end (further discussed in the detailed description of FIG. 3), which is proximal to a lower end of the central gripping member 202 for detachably attaching to and securely gripping the target object, for example, a gripping arm, a vacuum suction cup, a swing arm tool, a vehicle component, etc. In an embodiment, the interchangeable side plates 201 may be pivotally mounted using a mechanical joint 204 such as a shoulder bolted joint onto a robotic platform 101 (shown in dashed lines in FIG. 1). The mechanical joint 204 may also be used to suitably mount the modular clamp base 100 onto a driving mechanism of the robotic platform 101 such as a pneumatic drive, an electric drive, etc. In an embodiment, the mechanical joint 204 may include a U-bolt joint, a cotter pin bolt joint, or the like. Any suitable mechanical joint mechanism that facilitates movement such as movement along a linear path, movement along a circular path, etc., may be used in place of the mechanical joint 204 illustrated to describe the exemplary embodiment of the present disclosure.

Although the modular clamp base 100 or the subassembly 100 is described as being implemented in the EOAT, several other applications of the modular clamp base 100 may be envisioned without departing from the teachings of the present disclosure. For example, the modular clamp base 100 disclosed in FIG. 2 may be used in a swing unit with a partially rotating oscillating arm that advances components into position and returns to provide needed clearance. Typically, such a unit would have two stationary positions an advanced/extended and returned/retracted positions based on the driver of the partially rotating swing arm. As such, the interchangeable side plates 201 of the modular clamp base 100 may provide bearing support of the partially rotating oscillating member of the swing unit. Alternately, a unit could also be comprised of a continuous rotating member, for example, a pulley, gear, etc., that requires axial (thrust) support. In yet another embodiment, the modular clamp base 100 may be used in a linear drive unit using plain bearings. In such an application, the interchangeable plates 201 would provide a thrust-bearing surface to provide a bearing support when the linear drive unit moves along a linear path. As such, the terms “manipulate”, “maneuver”, “handle” used throughout the disclosure in relation to the target object may be construed to refer to causing a rotary motion, a linear motion, a reciprocating motion, or other motion of the target object.

FIG. 3 exemplarily illustrates an exploded perspective view of an embodiment of the modular clamp base 100 shown in FIG. 2. In accordance with another exemplary embodiment illustrated in FIG. 3, the modular clamp base 100 for manipulating a target object includes at least two interchangeable side plates 201 and a central gripping member 202. The interchangeable side plates 201 are configured to detachably attach to opposing surfaces (202a, 202b) of the central gripping member 202. Further, the central gripping member 202 includes an attachment end 202c, which is proximal to a lower end of the central gripping member 202 for detachably attaching to and securely gripping the target object. Each of the interchangeable side plates 201 includes one or more holes 201a configured to coaxially align with matching holes 202d configured in the central gripping member 202.

In accordance with an embodiment, the holes 201a and 202d of each of the interchangeable side plates 201 and the central gripping member 202 respectively may be threaded and maybe a through hole or a blind hole. The through hole may refer to any hole that is drilled, reamed, milled, etc., completely through the material of an object. On the other hand, a blind hole refers to a hole that is drilled, reamed, milled, etc., incompletely through the material of an object. In other embodiments, the holes 201a and 202d may be envisioned as plain holes without screw threads or helical grooves. The male attachment member 203, exemplarily illustrated in FIG. 2, may be configured with an external threaded surface or helical projection or plain surface to allow sufficient engagement thereby ensuring the three sections—the two interchangeable side plates 201 and the central gripping member 202 are firmly attached to function as a single unit.

Referring to FIGS. 2-3, in assembly, an embodiment of the modular clamp base 100 for manipulating a target object includes at least two interchangeable side plates 201, a central gripping member 202, and a male attachment member 203. Each of the interchangeable side plates 201 includes a hole 201a and the central gripping member 202 includes a hole 202d. Each hole 201a of the interchangeable side plates 201 is located, matched with the hole 202d of the central gripping member 202 to form an integral modular clamp base 100. The male attachment member 203 is used to fasten the interchangeable side plates 201 sandwiching the central gripping member 202 in between, thereby forming an integral unit. The interchangeable side plates 201 are detachably attached to opposing surfaces (202a, 202b) of the central gripping member 202 by inserting the male attachment members 203 through the holes 201a and 202d as exemplarily illustrated in FIGS. 2-3. Further, the central gripping member 202 includes an attachment end 202c,which is proximal to a lower end of the central gripping member 202. In an embodiment, the attachment end 202c is configured in a suitable shape that permits engagement with the target object that must be attached to the attachment end 202c. This target object may be a vehicle component, for example, a body panel, an engine component, a vehicle transmission component, etc. As such, the attached target object may be suitably handled, lifted, transported, or assembled using the modular clamp base 100. In one embodiment, there can be a pair of holes 201a that are spaced apart on top and bottom proximal ends of the two interchangeable side plates 201, as shown in FIG. 3. A pair of male attachment member 203 can be inserted through the pair of holes 201a to form an integral modular clamp base 100.

Further, each of the interchangeable side plates 201 includes a second hole 201b. A mounting attachment such as shoulder bolt, a U-bolt, a cotter pin bolt etc. can be used to pivotally mount modular clamp base 100 on a robotic platform 101 via a mechanical joint 204 thus formed. In an embodiment, the robotic platform 101 may include, for example, a Cartesian robot, a cylindrical coordinate system based robot, an articulated robot, a parallel robot, a polar coordinate system based robot, etc. In accordance with an embodiment, the mechanical joint 204, for example, a shoulder bolt is inserted into the second holes 201b provided in the two interchangeable side plates 201. This mechanical joint 204 is provided to facilitate mounting of the modular clamp base 100 to the drive mechanism of a robotic platform 101.

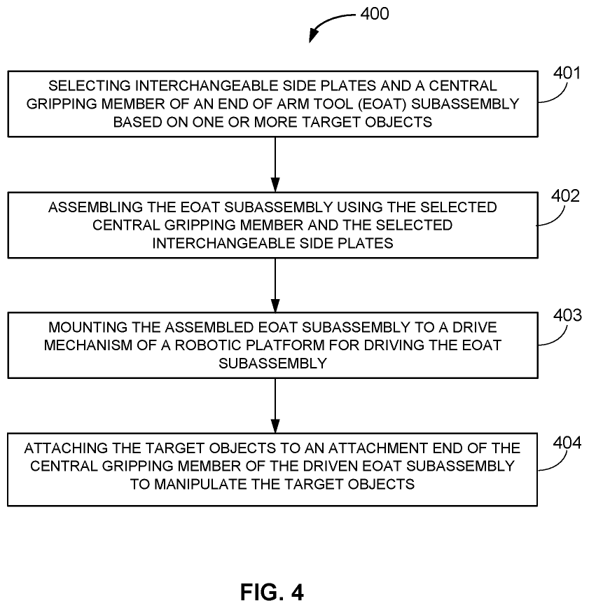

FIG. 4 exemplarily illustrates a flowchart showing a method 400 for manipulating a target object. The following description must be read in conjunction with FIGS. 1-4 to obtain a clearer idea about the operation of the modular clamp base 100. As disclosed in the detailed descriptions of FIGS. 2-3, the modular clamp base 100 comprises at least two interchangeable side plates 201, a central gripping member 202, male attachment members 203, and a mechanical joint 204.

At step 401 of method 400, disclosed herein, includes selecting at least two interchangeable side plates 201 and a central gripping member 202 of the modular clamp base 100 based on a type or size of a target object, for example, a gripping arm, a vacuum suction cup, a vehicle component, etc. The interchangeable side plates 201 may be both of same materials, for example, aluminum, anodized aluminum, or the like. Alternately, the interchangeable side plates 201 may be made of different materials. The mass of the selected interchangeable side plates 201 may also be varied based on the type, size, and mass range of the target object.

At step 402, the method 400 includes assembling the modular clamp base 100 by attaching the selected interchangeable side plates 201 to opposing surfaces 202a, 202b of the central gripping member 202. Assembling the modular clamp base 100 includes inserting the male attachment members 203 through the holes 201a and 202d of the interchangeable side plates 201 and the central gripping member 202, respectively. The inserted male attachment members 203 detachably attach the three sections—the interchangeable side plates 201 and the central gripping member 202 to form the modular clamp base 100. Further, the mechanical joint 204, for example, a shoulder bolted joint is created by inserting a shoulder bolt through the second holes 201b configured only in the interchangeable side plates 201.

At step 403, the method 400 includes mounting the assembled modular clamp base 100 to a drive mechanism of a robotic platform 101 using the mechanical joint 204. In an embodiment, the drive mechanism may include a pneumatic drive mechanism, an electric drive mechanism, or the like. The mechanical joint 204 provides a pivot about which the modular clamp base 100 may move or function. Although the exemplary embodiment illustrates a pivotally connected modular clamp base 100, several other mechanical joints having varying degrees of freedom in motion may be envisioned.

Finally, at step 404, the target object is mounted to an attachment end 202c of the central gripping member 202 of the modular clamp base 100 to manipulate the target object. The attachment end 202c of the central gripping member 202 is configured in a shape that facilitates mating of the target object with the attachment end 202c. The target object may include a vehicle panel, an engine block, an engine component, etc. Alternately, the target object may be an intermediate gripping arm, clamping tool, vacuum suction cup, etc., which may be used to lift, handle, or assemble multiple vehicle components.

The modular clamp base 100, disclosed herein, has interchangeable side plates 201 that permit testing of different materials, treatments and various bushings, or thrust washers. Further, the modular and interchangeable design of the modular clamp base 100 allows the entire unit to be rebuilt if needed and replaced when required quickly. Additionally, only the worn out component of the modular clamp base 100 need be replaced which allows for reduced material wastage and reduced time wastage thereby improving productivity in assembly lines. For example, only one of the interchangeable side plates 201 can be replaced, if needed. In some exemplary implementations, sensors or sensing devices may be employed in conjunction with the modular clamp base 100 in an Internet-of-Things (IoT) environment to monitor real time wear of the modular clamp base 100. The data so collected may be utilized to determine the average life of the modular clamp base 100 when using a particular combination of materials for the interchangeable side plates 201. Alternately, sensors may be employed to detect a vehicle component to be assembled and accordingly notify an operator if a tool change is required.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A subassembly for manipulating a target object, the subassembly comprising:
a central gripping member;
at least two interchangeable side plates configured to detachably attach to one of a first surface and an opposing second surface of the central gripping member; and
wherein the central gripping member comprises an attachment end proximal to a lower end of the central gripping member, the attachment end configured to manipulate the target object.

2. The subassembly according to claim 1, wherein the central gripping member further comprises a gripping member hole configured to receive a male attachment member.

3. The subassembly according to claim 2, wherein each of the interchangeable side plates further comprises a first side plate hole that is coaxially aligned to the gripping member hole and configured to receive the male attachment member to detachably attach each of interchangeable side plates to one of the first surface and the second surface.

4. The subassembly according to claim 3, wherein the first side plate hole comprises one of a through hole and a blind hole.

5. The subassembly according to claim 2, wherein the gripping member hole comprises one of a through hole and a blind hole.

6. The subassembly according to claim 1, wherein the target object is one of a gripping arm, a clamping tool, a vacuum suction cup, a swing arm tool, and a vehicle component.

7. The subassembly according to claim 1, wherein each of the interchangeable side plates is moveably mounted on a robotic platform through a mechanical joint.

8. The subassembly according to claim 1, wherein the attachment end of the central gripping member is configured to detachably attach to the target object.

9. A modular clamp base for manipulating a target object, the modular clamp base comprising:
a central gripping member comprising an attachment end configured to manipulate the target object;
at least two interchangeable side plates, each of the interchangeable side plates configured to coaxially align with the central gripping member;
a male attachment member configured to coaxially align and fasten each of the interchangeable side plates and the central gripping member to form an integral modular clamp base; and
wherein the central gripping member is configured to be coaxially aligned and sandwiched between each of the interchangeable side plates.

10. The modular clamp base according to claim 9, wherein each of the interchangeable side plates comprises a first side plate hole configured to coaxially align with a gripping member hole configured in the central gripping member.

11. The modular clamp base according to claim 10, wherein the male attachment member is configured to be inserted into the first side plate hole and the gripping member hole to detachably attach the interchangeable side plates to a first surface and an opposing second surface of the central gripping member.

12. The modular clamp base according to claim 10, wherein the gripping member hole and the first side plate hole of each of the interchangeable side plates are one of a through hole and a blind hole.

13. The modular clamp base according to claim 9, wherein the central gripping member is configured to one of rotate, extend, and retract the target object relative to the interchangeable side plates.

14. The modular clamp base according to claim 9, wherein the target object is one of a gripping arm, a clamping tool, a vacuum suction cup, a swing arm tool, and a vehicle component.

15. The modular clamp base according to claim 9, wherein each of the interchangeable side plates is detachably mounted to a robotic platform through a mechanical joint.

16. The modular clamp base according to claim 9, wherein each of the interchangeable side plates is made of one of similar materials and dissimilar materials.

17. A method for manipulating a target object comprising:
selecting at least two interchangeable side plates and a central gripping member of a modular clamp base based on the target object;
assembling the modular clamp base comprising attaching the interchangeable side plates to a first surface and an opposing second surface of the central gripping member;
mounting the modular clamp base to a robotic platform; and
attaching the target object to an attachment end of the central gripping member of the modular clamp base.

18. The method according to claim 17, wherein selecting the interchangeable side plates comprises selecting interchangeable side plates of a predefined material type and of a mass based on a mass and a size of the target object.

19. The method according to claim 17, wherein the interchangeable side plates are made of one of similar materials and dissimilar materials.

20. The method according to claim 17, wherein selecting the central gripping member comprises selecting a central gripping member comprising an attachment end configured to detachably attach to the target object.
